(19) United States
(12) Patent Application Publication
(10) Pub. No.: US 2015/0143333 A1
(43) Pub. Date: May 21, 2015

(54) Native Application Variation

(71) Applicant: Thunderhead Limited, London (GB)

(72) Inventors: Ray Gerber, London (GB); Glen Manchester, London (GB)

(21) Appl. No.: 14/318,904

(22) Filed: Jun. 30, 2014

(30) Foreign Application Priority Data
Nov. 19, 2013 (GB) 1320365.8

(51) Int. Cl. G06F 9/44

(52) U.S. Cl. CPC G06F 8/70
USPC 717/120

(57) ABSTRACT

From one aspect, a computer implemented method, apparatus and computer program product is provided for varying at least one element of a plurality of elements of a viewable area of a native software application during runtime on a first computing device, the method comprising highlighting at least one element of the viewable area of a native software application, receiving a user input relating to a selection of the element and information relating to a modification of the element; storing, as element information, an identifier of the selected element and the modification information of the selected element, and transmitting the element information to a server computer system if a network connection is available.

### CROSS-REFERENCE TO RELATED APPLICATIONS

This application claims priority to United Kingdom Patent Application No. GB1320365.8 filed on Nov. 19, 2013, which application is incorporated by reference herein in its entirety.

### FIELD OF INVENTION

The present invention relates to systems and computer-implemented methods for varying applications in a computing system. In particular, it relates to defining elements of native applications on a mobile computing platform, tracking interactions with such elements and enabling variation of elements in a native application.

### BACKGROUND

A native application 201 in the context of this disclosure is a software application that has been designed to run in a particular computing platform such as mobile platforms, Apple iOS™ or Google Android™ and is a locally installed application in the device 100 on which the mobile platform is provided. A native application 201 is in contrasted with a web application which is run in a web browser such as Internet Explorer™ or Chrome™, where such a web application is an application where all or some of the software is downloaded from the Internet each time it is run.

Analytic solutions such as Google Analytics exist and can monitor interactions with native applications. They rely on a software developer providing the particular instructions and code to the native application at the development stage to enable user interaction with such applications to be monitored by central servers. The software developer could be considered a resource with technical knowledge. If any changes need to be made to the native application, such changes need to be made by the software developer and the native application requires re-engineering at the development stage and re-distribution only if the user of the native application decides to update the native application. Also, a change in the code of the native application generally means that users that use the native application will have to install the new native application when updates are completed.

The inventors have found that an improved solution is needed to enable those that are not technically competent in development of the software such as business users to modify the native applications at run time and to allow for personalisation of the native application.

### SUMMARY OF THE INVENTION

From a first aspect, the present invention provides a computer implemented method for varying at least one element of a plurality of elements of a viewable area of a native software application during runtime on a first computing device, the method comprising: highlighting at least one element of the viewable area of a native software application; receiving a user input relating to a selection of the element and information relating to a modification of the element; storing, as element information, an identifier of the selected element and the modification information of the selected element; transmitting the element information to a server computer system if a network connection is available.

The method may further comprise receiving the element information in one or more other computing devices including the same native application as the first computing device and varying the element of the viewable area of the native application on the basis of the element information from the server computer system.

The varied element information is provided by the server computer system to the first computing device at a subsequent time to the modification of the element at the first computing device.

In an embodiment, the highlighting step includes highlighting a plurality of elements of the viewable area of the native application, and the user input relates to a selection of one or more of the elements.

In a further embodiment, if there is no network connection between the server computer system and the first computing device, the element information is stored temporarily in a memory unit of the computing device for manual transmission at some future time which is preferably the time when the device is reconnected to the network.

The element information is deleted from the memory unit once it has been successfully transmitted to the server computer system and the server computer system has verified successful receipt of the information.

In some embodiments, the computing devices are devices comprising a touch screen for receiving touch inputs and the user input can be a touch input on the touch screen.

Preferably, the method further comprises monitoring user interaction with at least one of the elements of the plurality of the elements of the native software application and generating interaction information based in the user interaction, the interaction information being stored in the computing device and transmitted to the server computer system if the network connection is available.

From a second aspect, the present invention provides a native application variation apparatus for varying at least one element of a plurality of elements of a viewable area of a native software application, the apparatus comprising:

element selector for receiving a user input relating to a selection of an element of a viewable area of a native software application and information relating to a modification of the element;

storing unit for storing, as element information, an identifier of the selected element and the modification information of the selected element;

transmitter for transmitting the element information to a server computer system if a network connection is available.

From another aspect, the present invention provides a computer program product comprising computer program instructions to, when loaded and executed on a computing device, cause the computing device to perform the steps of the aforementioned method.

From a fourth aspect, the present invention provides a computer implemented method for monitoring interaction with at least one element of a plurality of elements of a viewable area of a native software application during runtime on a first computing device, the method comprising: receiving a user input relating to a selection of the element; storing, as element information, an identifier of the selected element; transmitting the element information to a server computer system if a network connection is available. The method may further comprise varying the element in accordance with the first aspect.

From a fifth aspect, the present invention provides a native application interaction apparatus for monitoring interaction with at least one element of a plurality of elements of a viewable area of a native software application during runtime on a first computing device, the apparatus comprising:

event listener for monitoring user input relating to a selection of an element of a viewable area of a native software application;

storing unit for storing, as element information, an identifier of the selected element;

transmitter for transmitting the element information to a server computer system if a network connection is available. The apparatus may further be adapted to vary the at least one element in accordance with the second aspect.

From another aspect, the present invention provides a computer program product comprising computer program instructions to, when loaded and executed on a computing device, cause the computing device to perform the steps of the aforementioned method of the fourth aspect.

### BRIEF DESCRIPTION OF THE DRAWINGS

Embodiments of the invention will now be described in more detail, by way of example only, with reference to the drawings, in which:

FIG. 1 is a schematic representation of a computer system that may be used in embodiments of the present invention;

FIG. 2 is a schematic representation of an embodiment of a native application modification system;

FIG. 3 shows a schematic diagram of two native applications running on different devices in communication with a server computer system of FIG. 2 in another embodiment;

FIG. 4 is a flow chart of a method of the functional component of FIG. 2 according to an embodiment of user interaction when the device is not in administration mode;

FIG. 5 is a flow chart of a method of the functional component of FIG. 2 according to an embodiment of user interaction when the device is in administration mode; and

FIG. 6 is a flow chart of a method of the element modification controller of FIG. 2 according to an embodiment of activation of the native application when the device is not in administration mode.

### DETAILED DESCRIPTION

There is currently a system disclosed in the Applicant's earlier UK application no. 1222514.0 which is incorporated herein by reference where a web browser has a functional component (such as a plug in) to provide various functions to the web browser. The functional component can provide an element selection facility to a user of the web browser such that the user can select a web page element in a number of ways which can be varied. The web page element is variable in the sense that the content of the element can be changed on the basis of a selection or other action performed in another section of the web page.

The functional component is operable to store an identifier of the selected web page element at a server computer system. Therefore one of the web page elements is recorded for variation. The functional component is also operable to insert, inject or add an additional element to the web page. The additional element provides for the browser to render a variant of the web page such that the web page exhibits a variation of the variable element. The functional component may comprise an additional element inserter to insert, inject or add the additional element to the web page. The additional element inserts a script tag to the web page. The script tag can be a reference to an executable script stored in a server. The script tag includes a uniform resource location (URL) for the executable script and the URL refers to the location of the executable script on the server. The executable script can be operable to retrieve at least one modification instruction for the variable web page element. The modification instruction defines a modification to the variable element to be applied by the executable script executed by the web browser. The modification instruction can relate to the addition, removal or specification of one or more web page elements associated with the variable element.

In embodiments of the present invention, systems and methods are provided to enable those engaged with variation of information content, such as marketing professionals, who may not be competent to undertake technical development tasks of applications to undertake development and personalisation of native applications so as to define elements of native applications, track interactions with such elements and enable variation of elements in a native application.

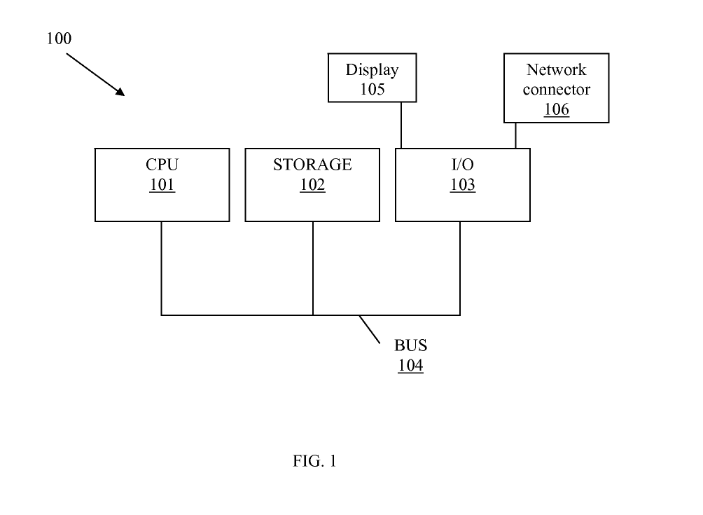

FIG. 1 is a schematic diagram of a computer system that may be used in embodiments of the present invention. The computer system is, in this embodiment, a mobile computing device 100 comprising a central processing unit 101 that is connected to a storage 102 and input/output interface 103 via a bus 104. The central processing unit 101 is preferably provided on a microprocessor. The storage 102 is a memory unit which can be any type of memory but is preferably non-volatile storage such as flash memory. The memory may be an integral part of the microprocessor. The input/output interface 103 is an interface to input and/or output devices. Such devices can include a display device 105 which is preferably a touch screen device that can also receive touch inputs from a user. The I/O interface may also connect to a network connector 106 to provide network connections such as Internet connections to the computing device 100.

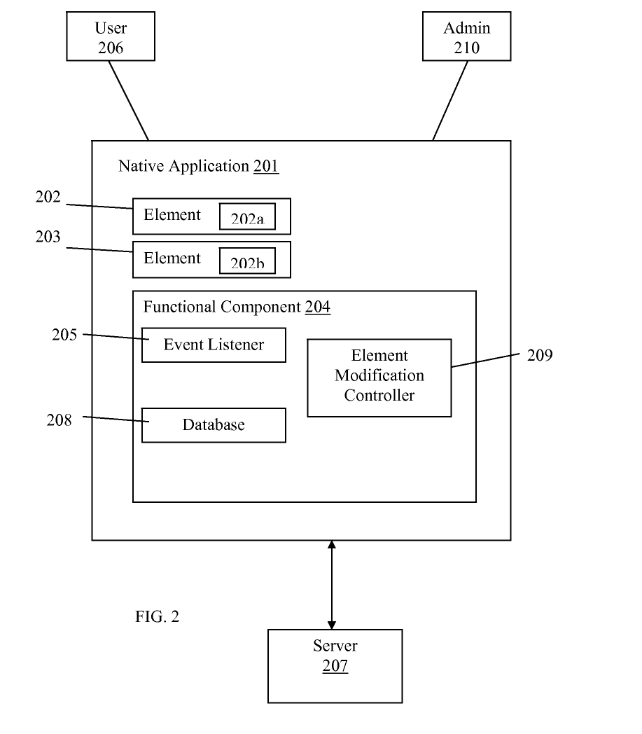

FIG. 2 is a schematic diagram showing an embodiment of a native application modification system.

The native application 201 may have a number of views or pages associated with it. Each page will include a graphical user interface with a viewable area and have a number of elements 202, 203 making up the page. The elements 202, 203 would have been developed during the development stage of the native application 201. Only two elements are shown but there may be one or more elements forming part of the page.

The native application 201 is provided with a functional component 204 to provide various functions to the native application 201. In one embodiment, the functional component 204 can provide an element modification facility to a user of the native application 201 which will allow a user to select a native application element 202, 203 in a number of ways to be varied. The functional component is integrated as part of the native application although it will be appreciated that the various functions of the functional component could be provided by single or multiple separate functional components which may or may not form part of the native application. The functional component may be provided in the form of a plug-in, extension or software development kit to extend the functionality of the native application.

The functional component 204 includes an event listener 205 for monitoring user interaction with one or more of the predetermined elements 202, 203 such that when the native application 201 is run on the computing device 100, user interaction with the one or more elements 202, 203 can be monitored and information relating to the interaction of the one or more elements by a user 206 can be sent to a server computer system 207 over a network connection that may be an Internet connection. The server computer system 207 may be a server that is preferably located remotely from and therefore separate to the computing device 100 such that device requires a network connection for the functional component 204 to communicate with the server computer system 207. The connection may be wired or wireless.

The interaction information which may include tracking data to track the element that has been interacted with by a user as a trackable event can be stored locally on the computing device 100 in a local database 208 created by the functional component and in memory of the device preferably when a network connection to the server computer system is not available. It will be appreciated that the interaction information can always be initially stored in the database 208 in the cache memory prior to being sent to the server computer system 207. The type of memory device will depend on the mobile computing device and in this embodiment is flash memory.

The local database 208 is operable to store information that fails to be successfully transmitted to the server computer system 207, for example, through failure of a connection between the device 100 and server computer system 207, or failure of a response from the server connection following a request to transmit the information from the device 100. The database 208 is adapted to store data that identifies the failure event and/or the time of the failure.

The functional component 204 is operable to store a unique identifier 202a, 202b relating to each one of the elements 202, 203 to be monitored in the mobile computing device 100.

The functional component 204 further comprises an element modification controller 209 to enable one or more elements 202, 203 of a native application page that form part of a view in the native application 201 to be varied and modified by an administrator.

The one or more elements 202, 203 may be selectable from a predetermined list of elements that can be monitored which is created during the development stage of the application 201. The selectable element 202, 203 can be selected in a number of ways. For example, this could be through direct selection of the element 202, 203 on the page of the native application 201 via a user touch event being detected on a display 105 of the device 100 that includes a touch screen. The touch event could be a tap on the screen of the touch screen of the device 100 or another type of touch input such as a two finger tap gesture. The element 202 may be displayed as part of the graphical user interface element that is a graphical representation (image) of the selectable element on the page on the native application 201 which can be highlighted with a heavy emphasis box, for example, to identify that the element 202 can be selected. Alternatively, the element could be selected from a drop down list of selectable elements.

In this embodiment, the functional component causes the one or more elements that can be varied to be highlighted and the native application 201 receives a selection of an element 202 to edit from a user. The user is preferably an administrator 210 that has been authenticated with the server computer system 207 and has therefore been given access to functionality relating to editing of the elements 202, 203. If any modifications are made to the native application page, the element modification controller 209 is operable to store the changes in the database 208 and send the changes preferably as an XML based file or application programming interface (API) as modification information to the server computer system 207 where the changes are stored. The modification information will include relevant information relating to the modification and identification information relating to native application page on which the change was made. Examples of modification can be one or more of an addition of a resource, a removal of a resource, a specification of the size of the element, and specification of one or more attributes of the element such as image data of the element. If there is no network connection to the server computer system 207, the update information cannot be sent and is either sent manually by the administrator 210 when such a connection is established at a later time or the update information is not sent and the process can be repeated. The changes are made by an administrator 210 at runtime of the native application 201 rather than at the development stage of the native application. Although only element 202 has been referred to in relation to modification, other or additional elements can be modified and the modification information can be stored in the database as different entries for sending to the server computer system 207.

The element modification controller 209 is operable to check the server computer system 207 for modifications the next time the native application page is activated by a normal user 206. Such a user 206 is different to the administrator 210 and is preferably not provided with access to functionality relating to editing of the elements 202, 203. On accessing a particular page, the element modification controller 209 performs a check to determine whether the page contains any editable elements and this can be achieved via a flag being applied to a page which has such elements. If a flag is present, the element modification controller 209 is adapted to send a request to the server computer system 207 to query whether any modification information is available for the particular page which will require an update to the page. If the answer to this query is in the affirmative, the element modification controller 209 is adapted to retrieve all or part of the modification information from the server computer system 207. The modification information may include commands and the element modification controller 209 interprets the commands and causes the elements to which the commands relate on the particular page to be modified in accordance with the modification information, for example, by interpreting the commands and assigning a new image to a new element location. The native application page can therefore be updated automatically to a user's device 100 via the server computer system 207 after an administrator 210 has updated one or more elements 202, 203 on the native application page on the administrator's device. The modification can be effected on the same device 100 as used by the administrator 210 the next time a normal user activates the native application 201 as in this embodiment.

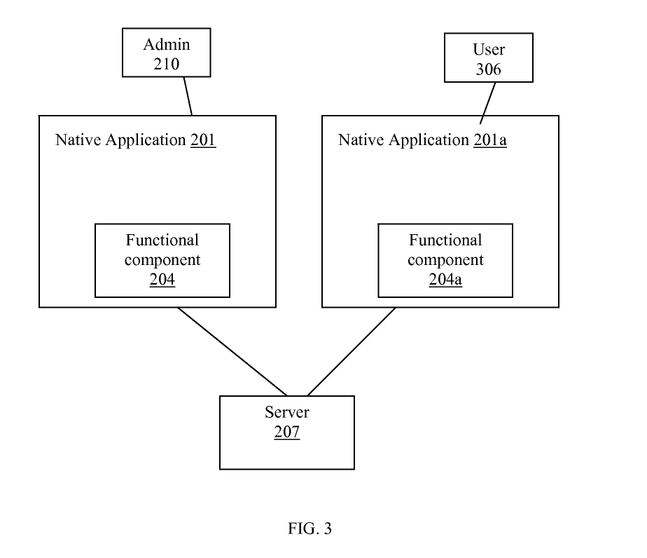

As shown in FIG. 3, the modifications can also be effected on another device which is running the native application. The native application 201 includes the functional component 204 which has the same functionality as that described with reference to FIG. 2 and the administrator 210 has modified the native application page and sent modification information to the server computer system 207 as described above. In this embodiment, a native application 201a which is the same as the native application 201 is run on another computing device and includes a functional component 204a which is similar to the functional component 204. The native applications 201, 201a contain the same elements (not shown) on a particular page. The device on which native application 201a is executed is communicatively coupled to the server computer system 207. The native application 201a is adapted to receive the modification information as was generated by the functional component 204 from the server computer system 207 and this will cause a modification to the native application page in native application 201a in accordance with the modification information the next time a user 306 opens the native application 201a provided there is a network connection path between the server 207 and the functional component 204a.

Therefore, in embodiments, a native application 201 can be updated dynamically, on the fly, without requiring a new application having to be downloaded or installed.

The elements 202, 203 are examples of areas on a native application page that can be varied or modified and may be visible to an administrator 210 due to the element modification controller 209 applying a visible overlay such as a grid to the page and each area of the grid being considered an element.

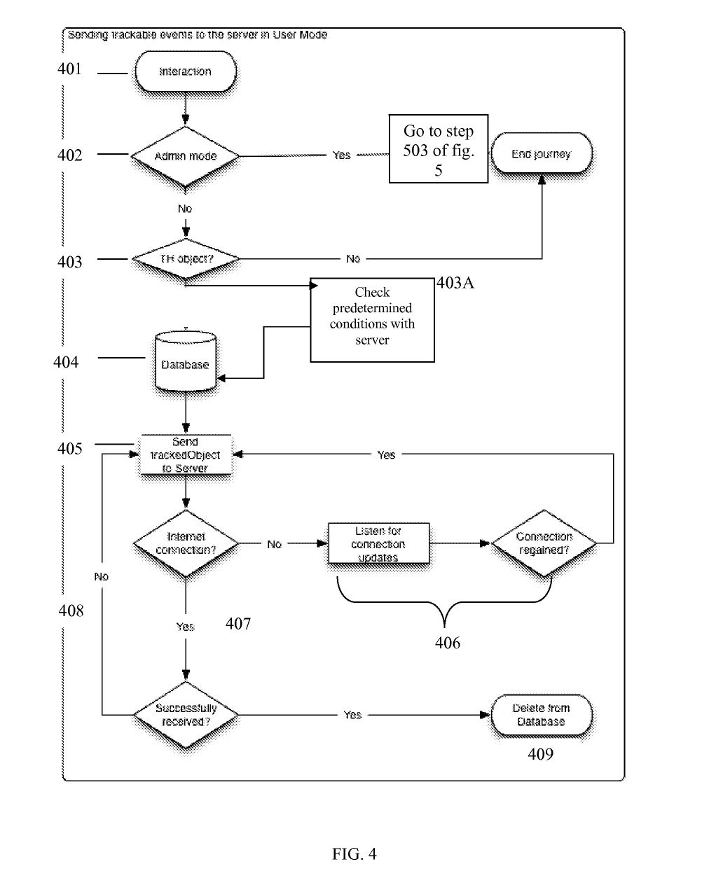

FIG. 4 is a flow chart of a method of the functional component of FIG. 2 according to an embodiment of user interaction when the device is not in administration mode. At step 401, a user interacts with the native application that has been activated on the computing device. The native application includes the functional component as described with reference to FIG. 2. The interaction is preferably a touch interaction on a touch screen of the computing device. At step 402, the functional component receives the interaction and checks to determine if the functional component is an administration mode. If the functional component is not in administration mode, in step 403, the functional component identifies whether there are any elements on the native application page that are trackable. If no trackable elements are identified on the native application page, no further action is taken. If a trackable element is identified, interaction with the trackable element can be monitored. A check can be made with server computer system to determine whether a set of predetermined conditions or condition rules are true in step 403A. One example of the predetermined conditions could relate to the type of user which will influence the frequency of the tracking. For example, if the user is customer associated with a particular type of service (eg. a wealth managed customer), every interaction with a trackable element may be recorded whereas for another type of customer, every instance of interaction may not be recorded and instead only intermittent recordal takes place, for example, recordal of when an element receives an interaction and future interactions with that same element in that session may not be recorded. Other types of conditions can be set at the time of native application creation.

If a network connection with the server computer system is not available when trying to execute the condition rules, then the object is stored in the database with an identifier that the object needs to be validated upon re-connection of the network connection.

The interaction with the trackable element(s), in step 404, is recorded as interaction information and stored in the database in the device memory, such information including identification information of the interacted elements. It will be appreciated that step 403A may be dispensed with and step 404 may directly follow step 403 without predetermined conditions having to be checked. An attempt is made by the functional component to send the identification information to the server computer system in step 405. If an internet connection cannot be established, in steps 406, the functional component will continue to listen for an internet connection and attempt to resend the information when the internet connection has been regained. If an internet connection can be established, in step 407, the response of the server computer system is checked; if the response is not successful, the functional component reattempts to send the interaction information in step 408. If an internet connection can be established, and the response from the server computer system is successful, the interaction information can be removed from the database in step 409.

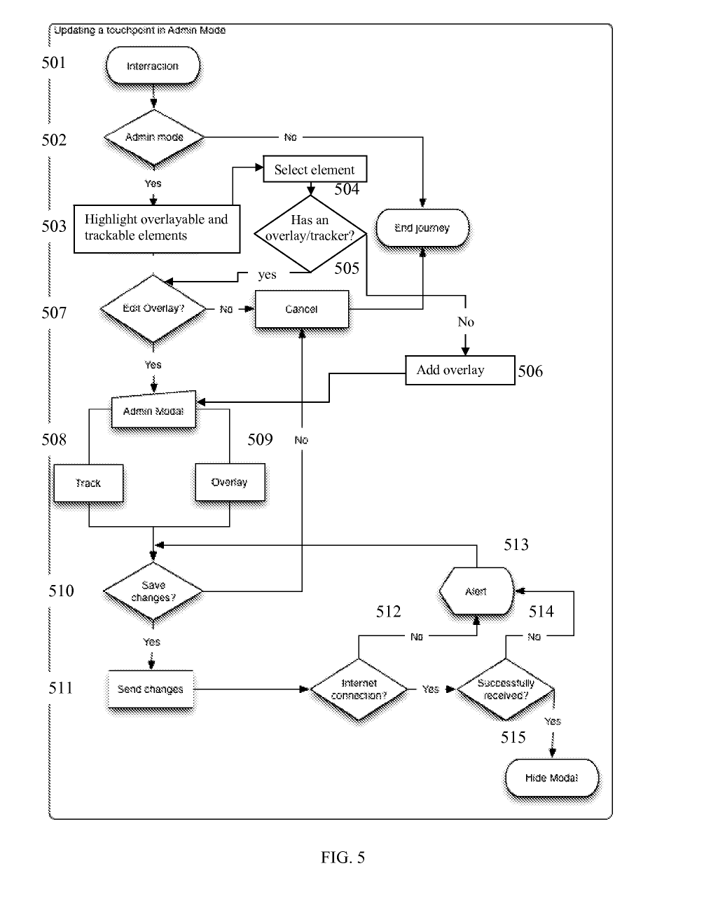

FIG. 5 is a flow chart of a method of the functional component of FIG. 2 according to an embodiment of user interaction when the device is in administration mode. A user interacts with the native application on the computing device in step 501. The native application includes the functional component as described with reference to FIG. 2. The functional component receives the interaction and checks to determine if the functional component is in an administration mode in step 502. If the functional component is in administration mode, the functional component in step 503 highlights all the overlayable and trackable elements of the native application page that can be modified for interaction by a user. A selection can be made by the administrator in step 504 and a check is made in step 505 whether the selected element has an overlay or tracker and is therefore modifiable. If no overlay or tracker exists, the administrator can add an overlay or tracker in step 506 to create a modifiable element. If an overlay or tracker exists meaning the element is already modifiable, a check is made whether the administrator wishes to edit the page in step 507. The functional component enables information relating to the modifiable elements to be edited by the administrator. The information can be tracking information (step 508) of the elements on a page or the overlay contents (step 509) such as the image of the element. The functional component may cause the changes to be saved in the local database in step 510. If changes are made to the page, in step 511, the functional component submits the changes to the server computer system via the internet connection. If no internet connection can be established, in step 512, the functional component will cause an alert (step 513) to be displayed on the screen of the device and the administrator will have the option to manually resubmit the information or cancel the operation. If an internet connection can be established but the server computer system is not responsive, in step 514, the functional component will cause an appropriate alert to be displayed and the administrator will have the option to manually resubmit the information or cancel the operation. If an internet connection can be established, and the response from the server computer system is successful, in step 515, a success message may be displayed on the screen of the device.

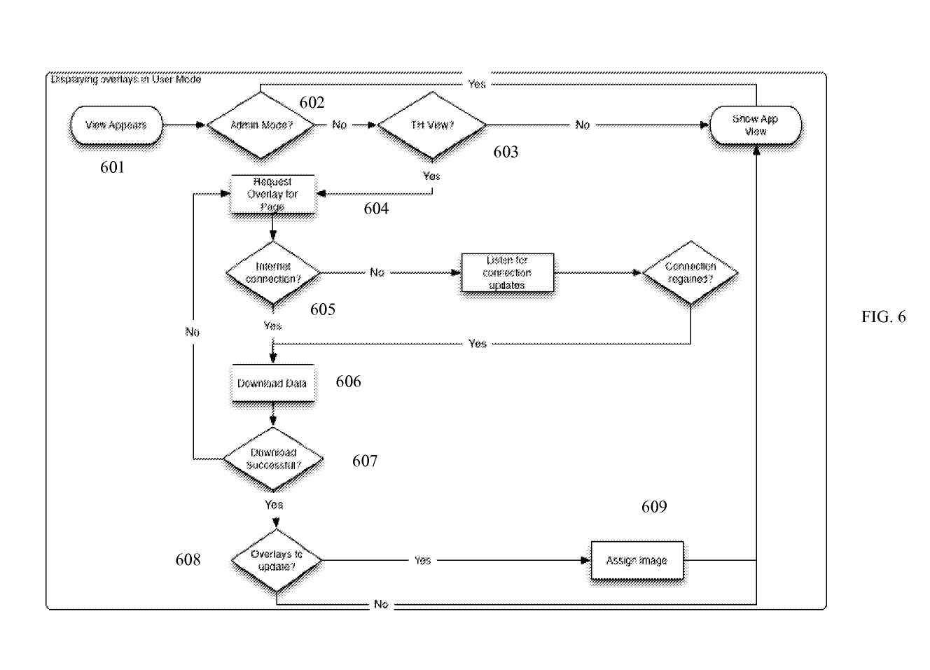

FIG. 6 is a flow chart of a method of the element modification controller of FIG. 2 according to an embodiment of activation of the native application when the device is not in administration mode. In step 601, a user activates a native application on the computing device. The native application includes the element modification controller as described with reference to FIG. 2. The element modification controller determines if it is in administration mode in step 602. If administration mode is not active, in step 603, a check is made to determine if the native application page includes elements that are trackable. If the native application page is such a page, in step 604, the element modification controller sends a request to the server computer system to query whether any modification information is available for the particular page which will require an update to the page. If the answer to this query is in the affirmative, the element modification controller checks in step 605 whether an internet connection is available, and if it is, retrieves in step 606 all or part of the update information from the server computer system. A check is made if the download is successful in step 607 and if it is, the element modification controller interprets the modification information in step 608. If a modification is required, in step 609 the element modification controller causes the page to be modified, for example, by interpreting the information and assigning a new image to a new element location.

It will be understood by those skilled in the art that the various features of the foregoing embodiments can be implemented on software or hardware, for example, on a software-controlled programmable processing device such as a computing device which could be a smartphone or tablet. A computer program for configuring the processing device may implement all or part of the functionality of the foregoing described methods on the computing device when the computer program is executed on it. The computer program is preferably stored on a computer program product.

In addition to the embodiments of the invention described in detail above, the skilled person will recognize that various features described herein can be modified and combined with additional features, and the resulting additional embodiments of the invention are also within the scope of the accompanying claims.

What is claimed is:

1. A computer implemented method for varying at least one element of a plurality of elements of a viewable area of a native software application during runtime on a first computing device, the method comprising: highlighting at least one element of the viewable area of a native software application; receiving a user input relating to a selection of the element and information relating to a modification of the element; storing, as element information, an identifier of the selected element and the modification information of the selected element; transmitting the element information to a server computer system if a network connection is available.

2. The method of claim 1 further comprising receiving the element information in one or more other computing devices including the same native application as the first computing device and varying the element of the viewable area of the native application on the basis of the element information from the server computer system.

3. The method of claim 1 wherein the varied element information is provided by the server computer system to the first computing device at a subsequent time to the modification of the element at the first computing device.

4. The method of claim 1 wherein the highlighting step includes highlighting a plurality of elements of the viewable area of the native application, and the user input relates to a selection of one or more of the elements.

5. The method of claim 1 wherein if there is no network connection between the server computer system and the first computing device, the element information is stored temporarily in a memory unit of the computing device for manual transmission at a different time.

6. The method of claim 1 wherein the element information is deleted from the memory unit once it has been successfully transmitted to the server computer system.

7. The method of claim 1 wherein the computing device is a device comprising a touch screen for receiving touch inputs and the user input is a touch input on the touch screen.

8. The method of claim 1 further comprising monitoring user interaction with at least one of the elements of the plurality of the elements of the native software application and generating interaction information based in the user interaction, the interaction information being stored in the computing device and transmitted to the server computer system if the network connection is available.

9. A native application variation apparatus for varying at least one element of a plurality of elements of a viewable area of a native software application, the apparatus comprising:
element selector for receiving a user input relating to a selection of an element of a viewable area of a native software application and information relating to a modification of the element;
storing unit for storing, as element information, an identifier of the selected element and the modification information of the selected element; and
transmitter for transmitting the element information to a server computer system if a network connection is available.

10. A computer program product comprising computer program instructions to, when loaded and executed on a computing device, cause the computing device to perform the steps of the aforementioned method.

11. A computer implemented method for monitoring interaction with at least one element of a plurality of elements of a viewable area of a native software application during runtime on a first computing device, the method comprising: receiving a user input relating to a selection of the element; storing, as element information, an identifier of the selected element; transmitting the element information to a server computer system if a network connection is available.

12. The method of claim 11 further comprising communicating with server computer system if a network connection is available to determine whether a set of predetermined conditions are true prior to storing the identifier of the selected element, and storing the identifier on the basis of the predetermined conditions.

13. A native application interaction apparatus for monitoring interaction with at least one element of a plurality of elements of a viewable area of a native software application during runtime on a first computing device, the apparatus comprising:
event listener for monitoring user input relating to a selection of an element of a viewable area of a native software application;
storing unit for storing, as element information, an identifier of the selected element; and
transmitter for transmitting the element information to a server computer system if a network connection is available.

14. A computer program product comprising computer program instructions to, when loaded and executed on a computing device, cause the computing device to perform the steps of the method of claim 11.
